(19) United States
(12) Patent Application Publication
(10) Pub. No.: US 2006/0222949 A1
(43) Pub. Date: Oct. 5, 2006

(54) Non-aqueous electrolyte secondary battery in which a carbon material is added to a negative-electrode active material

(75) Inventors: Yoshitaka Minamida, Sumoto-shi (JP); Seiji Morita, Sumoto-shi (JP); Nobuhiro Nishiguchi, Sumoto-shi (JP); Naoki Terada, Minamiawaji-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/391,698

(22) Filed: Mar. 29, 2006

(30) Foreign Application Priority Data
Mar. 30, 2005 (JP) 2005-99710

(51) Int. Cl. H01M 4/48; H01M 4/58; H01M 4/62; H01M 2/08

(52) U.S. Cl. 429/231.1; 429/231.95; 429/231.5; 429/232; 429/185

(57) ABSTRACT

Provided is a non-aqueous electrolyte secondary battery whose negative-electrode mixture contains a carbon material in addition to spinel-structure lithium titanium oxide (negative-electrode active material), and which realizes positive-electrode deterioration curbing and excellent battery performance. In the non-aqueous electrolyte secondary battery whose negative-electrode active material is mainly constituted by spinel-structure lithium titanium oxide, a carbon material that has a d002 spacing in a range of 0.335 nm to 0.340 nm, inclusive, and a bulk density smaller than 0.1 g/cm³ is added to the negative-electrode active material. Even when overcharged, the non-aqueous electrolyte secondary battery is restrained from undergoing excessive positive-electrode potential increase, and so is capable of largely restraining deterioration of the positive electrode.

### BACKGROUND OF THE INVENTION

(1) Field of the Invention

The present invention relates to a non-aqueous electrolyte secondary battery having a high capacity and a high performance, such as a lithium ion secondary battery.

(2) Related Art

In recent years, lithium ion secondary batteries are being put into use as a main power source and a memory backup power source of electronic devices, and use of lithium cobalt oxide and graphite as electrode materials is also being considered. Spinel-structure lithium titanium oxide (hereinafter simply “LiTiO”) is being particularly considered for use in a lithium ion secondary battery because LiTiO has a stable potential state and excellent charge/discharge characteristics.

For example, a Japanese Laid-open Patent Application No. H10-69922 discloses a lithium ion secondary battery that uses oxide manganese containing lithium as a positive electrode and LiTiO as a negative electrode. As disclosed therein, if the lithium ion secondary battery is overcharged and the positive electrode experiences potential increase, the crystalline structure will be broken, to deteriorate the battery performance and to dissolve the electrolytic solution. So as to prevent the positive electrode from reaching such an overcharged state, the invention sets the capacity of LiTiO of the negative electrode smaller than the capacity of the positive electrode as shown in FIG. 2A, to end charging by detecting change in battery voltage, making use of the potential change of the negative electrode.

As a different matter, LiTiO itself has low conductivity. Therefore from a practical point of view, it is necessary to produce an electrode by mixing LiTiO with a conductive agent. An example of the conductive agent is a carbon material such as graphite and carbon black. However, even if such a carbon material is used as a conductive agent, it is still difficult to satisfy both of conductivity attainment for the negative electrode and deterioration curbing for the positive electrode.

### SUMMARY OF THE INVENTION

The present invention has an object of providing a non-aqueous electrolyte secondary battery of excellent battery performance, whose positive electrode is restrained from deterioration and whose negative electrode maintains conductivity, where the negative-electrode mixture contains a carbon material in addition to spinel-structure lithium titanium oxide (a negative-electrode active material).

So as to achieve the stated object, the present invention has the following characteristics.

The negative-electrode mixture contains a carbon material that has a d002 spacing in a range of 0.335 nm to 0.340 nm, inclusive, and a bulk density smaller than 0.1 g/cm³. Here, the d002 spacing is an interlayer distance of a layer crystalline structure of the carbon material. As this value gets smaller, it indicates that crystallinity of the carbon material becomes higher. In particular, the present invention controls the content of the carbon material in the negative-electrode mixture, to lie in a range of 5 mass % to 20 mass % of the negative-electrode mixture, inclusive. Please note that the negative electrode according to the present invention contains a negative-electrode mixture in which the carbon material is added to the negative-electrode active material.

By controlling the content of the carbon material within the above range, the following effects will be obtained.

First, by defining the d002 spacing in the above range, it is possible to restrict the positive electrode from deterioration as detailed below. Generally when to end charging is detected by detection of battery voltage as mentioned above. If a carbon material having the interlayer distance range as stated above is adopted, the potential of the negative electrode exhibits a steep change in the vicinity of the full charge capacity (“A1” in FIG. 2B). This means that the charging is assuredly ended when the charged amount has reached the negative-electrode capacity, to restrict deterioration of the positive electrode attributable to the excessive increase of the positive-electrode potential. On the contrary, if carbon black having low crystallinity is adopted as a carbon material to be added, the potential change is gentle (slow) as shown by “A3” of FIG. 2B. Therefore by the time it is judged as charging ending, the charged amount will have exceeded the negative-electrode capacity. In the actual charging ending, sometimes it happens that the charged amount reaches a point where the positive-electrode potential indicates a steep increase, causing the positive electrode to deteriorate.

Second, since the present invention defines the bulk density of the carbon material in the above-stated range, even a small amount of the carbon material is able to form a conductivity network within the negative electrode. This is considered because a carbon material having a smaller bulk density more tends to have such particles as are adequately in contact with each other to form a chain-like structure, which generally helps generate an electrode having excellent conductivity. If graphite particles are adopted as a conductive agent, they also exhibit a steep potential change as “A1” of FIG. 2B, because their crystallinity is high. However if the bulk density of the graphite particles do not lie within the range that the present invention defines, the graphite particles disperse when mixed with LiTiO, which makes the graphite particles difficult to be in contact with each other. It is difficult for such particles to form a conductivity network. So as to counter this problem and to obtain desired conductivity, a comparatively large amount of the graphite particles becomes necessary. However, if the content of the graphite particles is increased, the content of the LiTiO in the negative-electrode material should be accordingly reduced, which incurs reduction of energy density in the electrode. The inventors have found that it becomes possible to obtain an electrode having excellent conductivity if the bulk density is set in the above range for a carbon material having the d002 spacing in the above range.

In sum, by adopting a carbon material having the d002 spacing in the above-defined range, and the bulk density in the above-defined range, it becomes possible to obtain a battery having an effect of performance deterioration curbing (First Effect) and a large capacity and a high output (Second Effect).

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a diagrammatic sketch of a battery structure according to the present embodiment;

FIG. 2A is a diagram showing potential changes respectively of a positive electrode and a negative electrode; and

FIG. 2B is a diagram showing a negative electrode's potential change towards the full charge.

### DESCRIPTION OF THE PREFERRED EMBODIMENTS

### EMBODIMENT

The following describes the best mode for carrying out the present invention.

1. Structure of Battery

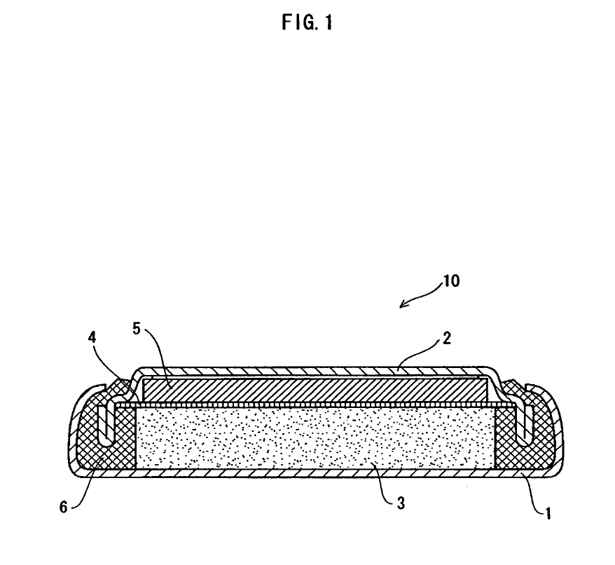

A non-aqueous electrolyte secondary battery 10 (hereinafter simply “battery 10”) adopted by the present embodiment has a flat shape as shown in FIG. 1 and is so called a button-type battery. The outer structure of the battery 10 is composed of a positive-electrode casing 1 having an opening, and a negative-electrode casing 2 functioning as a cap with which the opening is sealed. Inside the battery 10, a positive electrode 3, a separator 4, and a negative electrode 5 are stacked on the positive-electrode casing 1. Besides, the battery 10 has an electrolytic solution (not shown in the drawing) injected therein. The stated components of the battery 10 are detailed as follows.

(Positive Electrode 3)

The positive electrode 3 is generated by subjecting, to pressure forming, a positive-electrode active material that is capable of occluding and releasing lithium and a positive-electrode mixture that contains a conductive agent.

The main constituent of the positive-electrode active material is lithium cobalt oxide. The conductive agent is mainly composed of acetylene black and graphite. The positive-electrode mixture results by mixing lithium cobalt oxide, acetylene black, graphite, and a binding agent, in a mass ratio of 85:5:5:5 in the stated order. Then the positive-electrode mixture is subjected to the pressure forming, thereby completing a positive electrode having a diameter of 4 mm and a thickness of 0.9 mm. Note that the binding agent is preferably a fluororesin having a high melting point (e.g. polyfluoride vinylidene (PVDF)).

(Separator 4)

The separator 4 is made of bonded polyolefin, bonded polyolefin containing glass fibers, a microporous polyolefin film, and the like. The separator 4 may be made of other materials as long as they are insulative, are capable of retaining the electrolytic solution, and are stable for a long time within the electrolytic solution.

(Negative Electrode 5)

The negative electrode 5 is generated by subjecting, to pressure forming, a negative-electrode active material that is capable of occluding and releasing lithium and a negative-electrode mixture that contains a conductive agent.

The main constituent of negative-electrode active material is LiTiO (spinel-structure lithium titanium oxide). The negative-electrode mixture results by mixing the negative-electrode active material, the conductive agent (carbon material), and a binding agent, in a mass ratio of 90:5:5 in the stated order. Then the negative-electrode mixture is subjected to the pressure forming, thereby completing a negative electrode having a diameter of 4 mm and a thickness of 0.6 mm. Note that adequate conditions about the carbon material used as the conductive agent (e.g. type and mass) are detailed later under the title of “Confirmation Test”.

(Electrolytic Solution)

An electrolytic solution is prepared in the following manner. Ethylene carbonate (EC) and diethyl carbonate (DEC) are mixed at a volume ratio of 1:2, to obtain a solution. Then a lithium hexafluorophosphate (LiPF₆) is added to the solution in the ratio of 1 mol/l, thereby completing the electrolytic solution.

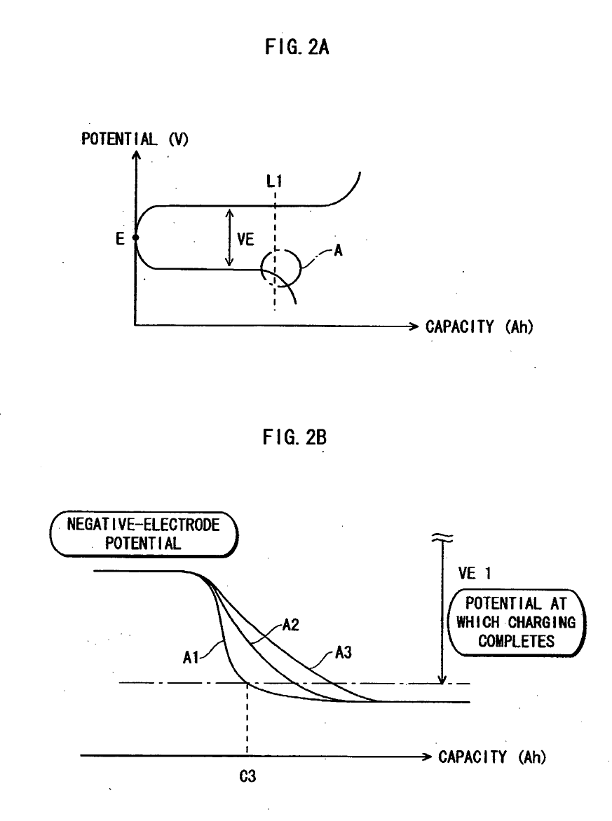

In the battery 10 made up of the mentioned materials, the positive electrode is larger than the negative electrode in terms of capacity, and the potential changes steeply for each of the electrodes due to movement of Li-ion (see FIG. 2A), just as in the conventional cases.

A lithium ion secondary battery is produced in the above way, where the produced lithium ion secondary battery is specifically a button-type non-aqueous electrolyte secondary battery having a nominal capacity of 3 mAh.

2. Confirmation Test

1^{st}Test: Comparison of Carbon Materials

(1) Kinds of Batteries Used in the Test

The first test was conducted using batteries having the same structure as that of the button-type lithium ion secondary battery, already described under the title of “1. Structure of Battery”. However, each battery uses a respective conductive agent for its negative electrode as listed below:

### EMBODIMENT EXAMPLE 1

Vapor grown carbon fiber (VGCF) having d002=0. 337 nm, and a bulk density of 0.04 g/cm³

### EMBODIMENT EXAMPLE 2

VGCF having d002=0.339 nm, and a bulk density of 0.04 g/cm³

### EMBODIMENT EXAMPLE 3

VGCF having d002=0.339nm, and a bulk density of 0.09 g/cm³

### COMPARISON EXAMPLE 1

VGCF having d002=0.339 nm, and a bulk density of 0.20 g/cm³

### COMPARISON EXAMPLE 2

VGCF having d002=0.342 nm, and a bulk density of 0.04 g/cm³

### COMPARISON EXAMPLE 3

Graphite particles having d002=0.336 nm, and a bulk density of 0.15 g/cm³

### COMPARISON EXAMPLE 4

Acetylene black having d002=0.350 nm, and a bulk density of 0.15 g/cm³

### COMPARISON EXAMPLE 5

Ketjen black having d002=0.370 nm, and a bulk density of 0.03 g/cm³

(2) Details of the Test

(2-1) Overcharge Test

At an environmental temperature of 60° C., and by being connected to a direct current power source of 3V via a resistance of 1 kΩ, each battery was subjected to constant voltage charge for the period of 20 successive days, and the internal resistance in each battery is measured before and after the period.

(2-2) Discharge Test

Each battery is charged for 50 hours by being connected to a direct current power source of 3V via a resistance of 1 kΩ. Thereafter, the battery is connected to a resistance of 100 kΩ, so as to measure the discharge capacity up to 2V.

(3) Test Result

(3-1) Result of Overcharge Test

Table 1 shows the result of the overcharge test, in respect of the embodiment examples 1-3 and the comparison examples 1-5. “resistance change” in Table 1 is an index (%) showing a change of internal resistance of a corresponding battery between before and after the test.

TABLE 1

| | | Discharge |
|---|---|---|
| | Resistance Change | Capacity (mAh) |
| Embodiment Example 1 | 110 | 2.98 |
| Embodiment Example 2 | 132 | 2.96 |
| Embodiment Example 3 | 135 | 2.78 |
| Comparison Example 1 | 139 | 1.86 |
| Comparison Example 2 | 321 | 2.93 |
| Comparison Example 3 | 108 | 1.43 |
| Comparison Example 4 | 394 | 1.78 |
| Comparison Example 5 | 2146 | 3.01 |

As shown in Table 1, if a carbon material whose d.002 spacing is no greater than 0.340 nm is employed, as in the embodiment examples 1-3 and the comparison examples 1 and 3, the increase in internal resistance is restrained compared to the comparison examples 2, 4, and 5 that use carbon materials whose d002 spacing is greater than 0.340 nm. This is considered because if the d002 spacing of an employed carbon material is no greater than 0.340 nm, the potential change at full charge of LiTiO is steep (see “A1” in FIG. 2B), to instantly stop further charging at the full charge, prevent the positive electrode from being subjected to unnecessary further charging and further from deterioration. On the other hand, in the cases of the comparison examples 2, 4, and 5, at full charge of LiTiO, the potential change is gentle (see “A3” in FIG. 2B), and so charging continues for a while even after reaching the full charge, subjecting the positive electrode to overcharge to be deteriorated, which has heightened the internal resistance.

It comes to the conclusion that the preferable range of the d002 spacing for a carbon material to be added is at least no greater than 0.340 nm. Note that a carbon material has a layer structure, and the ideal graphite whose interlayer spacing is the smallest has the logical value of d002 of 0.335 nm. Therefore, it is obvious that each carbon material used in the present embodiment has a d002 spacing of 0.335 nm or above.

(3-2) Discharge Capacity Measurement Result

As shown in Table 1, if a carbon material whose bulk density is no greater than 0.10 g/cm³ is employed, as in the embodiment examples 1-3 and the comparison examples 2 and 5, the discharge capacity is approximately 3.00 mAh, which is about the same as the nominal capacity. However, in the cases of the comparison examples 1, 3, and 4, which use carbon materials whose bulk density is greater than 0.10 g/cm³, the resulting discharge capacity was smaller than the nominal capacity. This is attributable to the fact that, when keeping the added amount of a carbon material constant, the particles of the carbon material tend to be combined more as the bulk density of the carbon material gets smaller, which helps better maintain the conductivity network within the electrodes, to heighten the conductivity of the electrodes.

The test results show that the batteries of the embodiment examples 1-3 are not subjected to large deterioration of internal resistance within the batteries, and are capable of maintaining a favorable state with respect to discharge capacity. Therefore, these batteries are said to have such characteristics as high capacity and high output, and are not subjected to noticeable deterioration in battery performance even in the overcharge state when compared to the conventional cases. As a result, a preferable carbon material (e.g. VGCF) at least has a d002 spacing of no greater than 0.340 nm, and a bulk density of no greater than 0.1 g/cm³. The most favorable condition of carbon material is a d002 spacing in the range of 0.335 nm to 0.340 nm, inclusive, and a bulk density in the range of 0.04 g/cm³ to 0.10 g/cm³, inclusive.

2^{nd} Test: Further consideration was performed in respect of the added amount of the carbon material used in the embodiment example 1 of the 1^{st} test. In the 2^{nd} test, batteries respectively having a corresponding negative electrode (see the following list) were produced, and the same discharge test as performed in the 1^{st} test was conducted using the produced batteries, for checking the capacity.

### EMBODIMENT EXAMPLE 1a

a negative electrode containing 20 mass % of VGCF of the embodiment example 1

### EMBODIMENT EXAMPLE 1b

a negative electrode containing 10 mass % of VGCF of the embodiment example 1

### EMBODIMENT EXAMPLE 1c

a negative electrode containing 1 mass % of VGCF of the embodiment example 1

### COMPARISON EXAMPLE 6

a negative electrode containing 0.5 mass % of VGCF of the embodiment example 1

Table 2 shows the result of the discharge test in respect of the embodiment examples 1, 1a, 1b, and 1c, and the comparison example 6.

TABLE 2

| | Negative- | |
|---|---|---|
| | Electrode Composition | |
| | Mass Ratio (Lithium | |
| | Titanium Oxide:Carbon | |
| | Material:Bonding | Discharge |
| | agent) | Capacity (mAh) |
| Embodiment | 90:5:5 | 2.98 |
| Example 1 | | |
| Embodiment | 75:20:5 | 2.63 |
| Example 1a | | |
| Embodiment | 85:10:5 | 2.95 |
| Example 1b | | |
| Embodiment | 94:1:5 | 1.92 |
| Example 1c | | |
| Comparison | 94.5:0.5:5 | 0.24 |
| Example 6 | | |

As shown in Table 2, the embodiment examples 1 and 1b have achieved the capacity of approximately 3.0 mAh, which is substantially the same as the nominal capacity. The embodiment example la has also achieved a level of discharge capacity fairly comparable to the counterparts of the embodiment examples 1 and 1b. Still further, the embodiment example 1c is also said to maintain a favorable output although its discharge capacity is lower, in some degree, than the counterparts of the embodiment examples 1a and 1b.

On the other hand, the comparison example 6 has a further reduced discharge capacity, which cannot be said as sufficient.

Therefore, it is confirmed that the largest discharge capacity results when the added ratio of the carbon material is substantially in the range of 5-10 mass % of the negative-electrode mixture, exhibiting the most preferable conductivity. When the added ratio is 20 mass %, substantially the same level of discharge capacity is obtained although there is some reduction in discharge capacity when compared to a case where the added ratio is in the range of 5-10 mass %. However, when the added ratio is reduced to 1 mass %, considerable reduction in discharge capacity was observed. As a result, it is confirmed preferable that the added ratio of the carbon material to the negative-electrode mixture is in the range of 5 mass % to 20 mass %, inclusive, so as to maintain a favorable battery discharge capacity.

It should be noted here that although each non-aqueous electrolyte secondary battery used in the embodiment is a button-type, the present invention is also applicable to a non-aqueous electrolyte secondary battery of other shapes, such as a cylindrical shape whose electrode body results from winding positive and negative electrode plates with a separator therebetween, and a rectangular shape whose electrode body results from stacking positive and negative electrode plates with a separator therebetween.

Although the present invention has been fully described by way of examples with references to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A non-aqueous electrolyte secondary battery comprising:
a positive electrode containing a positive-electrode mixture that contains a positive-electrode active material whose main constituent is lithium; and
a negative electrode facing the positive electrode, the negative electrode containing a negative-electrode mixture that contains a negative-electrode active material whose main constituent is spinel-structure lithium titanium oxide, wherein the negative-electrode mixture further contains a carbon material that has a d002 spacing in a range of 0.335 nm to 0.340 nm, inclusive, and a bulk density smaller than 0.1 g/cm³.

2. The non-aqueous electrolyte secondary battery of claim 1, wherein
the content of the carbon material is in a range of 5 mass % to 20 mass % of the negative-electrode mixture, inclusive.

3. The non-aqueous electrolyte secondary battery of claim 1, wherein
the d002 spacing of the carbon material is in a range of 0.335 nm to 0.340 nm, inclusive, and the bulk density of the carbon material is in a range of 0.04 g/cm³ to 0.10 g/cm³, inclusive.

4. The non-aqueous electrolyte secondary battery of claim 1, wherein
the carbon material is a vapor grown carbon fiber (VGCF).

5. The non-aqueous electrolyte secondary battery of claim 1, wherein
the positive electrode is larger, in capacity, than the negative electrode.

6. The non-aqueous electrolyte secondary battery of claim 1, wherein
the main constituent of the positive-electrode active material is lithium cobalt oxide.

7. The non-aqueous electrolyte secondary battery of claim 6, wherein
the positive-electrode mixture further contains acetylene black and graphite, in addition to the positive-electrode active material.

8. The non-aqueous electrolyte secondary battery of claim 1, further comprising:
a positive-electrode casing having an opening; and
a negative-electrode casing with which the opening of the positive-electrode casing is sealed, wherein
the positive electrode and the negative electrode are stored in sealed space created between the positive-electrode casing and the negative-electrode casing.

9. The non-aqueous electrolyte secondary battery of claim 8, being of a button-type.
